(19) United States
(12) Patent Application Publication
(10) Pub. No.: US 2014/0283079 A1
(43) Pub. Date: Sep. 18, 2014

(54) STEM CELL GRID

(71) Applicant: REMTCS Inc., Red Bank, NJ (US)

(72) Inventors: Tommy Xaypanya, Lamar, MS (US); Richard E. Malinowski, Colts Neck, NJ (US)

(73) Assignee: REMTCS Inc., Red Bank, NJ (US)

(21) Appl. No.: 14/216,634

(22) Filed: Mar. 17, 2014

Related U.S. Application Data
(60) Provisional application No. 61/794,430, filed on Mar. 15, 2013.
(60) Provisional application No. 61/794,472, filed on Mar. 15, 2013.
(60) Provisional application No. 61/794,505, filed on Mar. 15, 2013.
(60) Provisional application No. 61/794,547, filed on Mar. 15, 2013.
(60) Provisional application No. 61/891,598, filed on Oct. 16, 2013.
(60) Provisional application No. 61/897,745, filed on Oct. 30, 2013.
(60) Provisional application No. 61/901,269, filed on Nov. 7, 2013.

(51) Int. Cl. H04L 29/06; H04L 12/24

(52) U.S. Cl. CPC H04L 63/145; H04L 41/0659
USPC 726/24

(57) ABSTRACT

A stem cell grid is disclosed. The stem cell grid includes the ability to incorporate characteristics of a stem cell into a network device. In the event that the network device fails or otherwise becomes unavailable for use by other network devices, the network device is automatically replicated within a virtualized environment and then the replica of the network device is used instead of the failed and/or unavailable network device.

### CROSS-REFERENCE TO RELATED APPLICATIONS

The present application claims the benefit of U.S. Provisional Patent Application Nos. 61/794,430, 61/794,472, 61/794,505, 61/794,547, 61/891,598, 61/897,745, and 61/901,269, filed on Mar. 15, 2013, Mar. 15, 2013, Mar. 15, 2013, Mar. 15, 2013, Oct. 16, 2013, Oct. 30, 2013, and Nov. 7, 2013, respectively, each of which are hereby incorporated herein by reference in their entirety.

### FIELD OF THE DISCLOSURE

The present disclosure is generally directed to network preservation and methods of implementing the same.

### BACKGROUND

Network failures are inevitable. While many enterprises and individuals do their best to provide backup/failover solutions (also known as high availability) for their mission-critical network devices, there is still the risk of a catastrophic failure disrupting service. This is especially true when a network is attacked by a computer virus or malware.

The process of recovering a device or network is extremely time consuming, difficult, and expensive. Not to mention, every minute that a device or network is down may result in lost business opportunities or additional costs.

### SUMMARY

It is, therefore, one aspect of the present disclosure to provide a stem cell grid. In some embodiments, the disclosed stem cell grid technology gains inspiration from the human stem cell. Specifically, embodiments of the present disclosure incorporate cellular functions and characteristics (e.g., cellular growth properties, dividing and duplication properties, genetic algorithms, etc.) of a stem cell into a networking solution that automates the creation and/or replication of any networking product (e.g., switches, firewalls, endpoints, etc.). In other words, the stem cell grid as disclosed herein, provides network devices and the network as a whole with the ability to virtualize and replicate themselves. This ultimately results in the ability to provide a disaster recovery solution for critical network infrastructure.

In some embodiments, this universal networking/server environment is capable of virtualizing and segmenting networking devices and/or services (e.g., software, applications, etc. operating on a network device) through the use of an artificial neural network intelligent interface, ANNI, running on a supercomputer.

Some aspects of the present disclosure include, without limitation:

1) Design from the ground up to be a “Machine learning” system within a High Performance Computing environment that understands (at default) ‘industry standards’ networking systems & information technology practices.

2) A.I. managed and driven replications technology that eliminates networking administrational needs and false positive.

3) Built on a “real time secured” hypervisor technology coupled with data bursts & ultra-low latency technology, to expedite communications from data store to CPU.

In accordance with embodiments, stem cell grid provides the ability to create/allow or delete/clone/backup switches, servers, endpoints, routers, gateways, telecommunication services, and/or any other network device, computing device, or collection of devices. Using a backend artificial neural network intelligence, ANNI, network devices and the infrastructure connecting such devices can be created in real time by using virtualization technology coupled with dark fiber power over Ethernet.

In some embodiments, the A.I. Engine (ANNI) is taught and designed to understand multiple “industry standard”, best practice networking system configurations/firewalls/switches/PASS security- to secure network assets (e.g., anything that's necessary or desirable for a network to be secure).

In some embodiments, ANNI is configured to create snapshots of the current network environment in real time in an Active/Passive mode in microseconds. If a network or component thereof goes down, ANNI has the ability to bring back the latest network configuration-in minutes.

A non-limiting example of how to implement such a system includes: Equip the walls with Fiber & power over Ethernet sockets. Allow users to simply plug devices into the network or critical portions of the network via a Ethernet or wireless connections, which then get assigned and recorded as an asset into “stem cell” blade servers. ANNI will create the networking services on the backend to account for bandwidth and resource balancing or sharing.

Embodiments of the present disclosure provide the ability to redirect an attack to an on the fly newly created virtual network. Thus, the stem cell grid provides the ability to bring back up to a degraded network due to DDOS, etc. within minutes. Moreover, the stem cell grid provides the ability to maintain network operational availability (High Availability) and a duplicate network can be created with the same internet protocol addresses. The stem cell grid further provides the opportunity to direct attacks to virtual network and can, if desired, demonstrate a failed network. In general, the stem cell grid provides a mechanism to return mission critical systems to operations quickly.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Also, while the disclosure is described in terms of exemplary embodiments, it should be appreciated that individual aspects of the disclosure can be separately claimed. The present disclosure will be further understood from the drawings and the following detailed description. Although this description sets forth specific details, it is understood that certain embodiments of the disclosure may be practiced without these specific details. It is also understood that in some instances, well-known circuits, components and techniques have not been shown in detail in order to avoid obscuring the understanding of the invention.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The present disclosure is described in conjunction with the appended figures:

FIG. 1 is a block diagram depicting a communication system in accordance with embodiments of the present disclosure;

FIG. 2 is a flow chart depicting a method of creating and managing a duplicate network in accordance with embodiments of the present disclosure;

FIG. 3 is a flow chart depicting a method of responding to a network attack in accordance with embodiments of the present disclosure; and

FIG. 4 is a flow chart depicting a method of responding to a network or network component failure in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Referring initially to FIG. 1, a communication system 100 is depicted in accordance with embodiments of the present disclosure. The communication system 100 is shown to include an actual corporate network 112 and a virtual or duplicate corporate network 116 connected to an unsecured network, such as the Internet 104, via a gateway 108 or similar network boundary device.

The networks 112, 116 may actually correspond to any type of network (e.g., non-corporate network), even though such networks are labeled as a corporate network. Furthermore, the networks 112, 116 may correspond to any single device or collection of devices that are capable of exchanging or carrying data packets between computational/communication devices. Non-limiting examples of networks 112, 116 include a Local Area Network (LAN), a Personal Area Network (PAN), a Wide Area Network (WAN), Storage Area Network (SAN), backbone network, Enterprise Private Network, Virtual Network, Virtual Private Network (VPN), an overlay network, a Voice over IP (VoIP) network, combinations thereof, or the like.

In some embodiments, the actual network 112 may be connected directly to the gateway 108 whereas the virtual network 116 may be connected to the gateway 108 via a sentinel server 120. The sentinel server 120, in some embodiments, may include a stem cell grid 124 that is configured to create and manage the virtual network 116 as described in further detail herein. Specifically, the sentinel server 120 may correspond to one or multiple servers or, alternatively, one or multiple blades within a server or similar or High Performance Computing (HPC) environment. In some embodiments, the stem cell grid 124 may be configured to identify assets connected to the actual network 112, examples of which may include email server 128, web server 132, other servers 136, user devices 140, and the like. Once an asset has been identified as being connected to the actual network 112, the stem cell grid 124 may assign and record the same asset at the virtual network 116, thereby creating a substantial duplicate or clone of the actual network 112. The stem cell grid 124 may automatically identify any new asset connected to the actual corporate network 112 when such an asset is plugged into or connected to the network (e.g., wired or wireless connection).

It should be appreciated that while the particular assets 128, 132, 136, 140 are shown as being connected to the actual network 112 and then duplicated on the virtual network 116, embodiments of the present disclosure are not so limited. Specifically, assets that temporarily connect to a network via wireless communication protocols (e.g., WiFi, Bluetooth, ZigBee, ZWave, etc.) may also be automatically recognized by the stem cell grid 124 and duplicated on the virtual network 116 even though such assets are only temporarily connected to the actual network 112. For instance, a cellular phone, tablet, or laptop that establishes a temporary connection via a secure or unsecure WiFi connection with the actual network 112 may be duplicated on the virtual network 116 by the stem cell grid 124. Other types of assets that may be connected to the actual network 112 and duplicated on the virtual network 116 include, without limitation, printers, copiers, fax machines, personal communication devices, peripheral devices, databases, server clusters, etc.

The gateway 108 may correspond to any type of known network border device. Non-limiting examples of suitable devices that can operate or behave as a gateway 108 include Session Border Controllers (SBCs), firewalls, routers, Network Address Translators (NATs), combinations thereof, or the like. The gateway 108, in some embodiments, corresponds to a collection of hardware and software components configured to separate and protect the actual network 112 from the untrusted network 104 and devices connected thereto.

As mentioned above, the sentinel server 120 and stem cell grid 124 may be responsible for creating and managing the virtual network 116. The sentinel server 120 and/or stem cell grid 124 may also be configured to monitor the actual network 112 for failures, outages, or potential attacks directed thereto and, in response to detecting such an event, utilize the virtual network 116 to either quarantine attacks and/or rebuild a failed portion of the actual network 112.

With reference now to FIG. 2, additional details regarding a method of building and maintaining a virtual network 116 will be described in accordance with embodiments of the present disclosure. The method begins with the stem cell grid 124 determining the characteristics of the actual network 112 (step 204). In this step, the stem cell grid 124 may identify some or all of the assets connected to the actual network 112 and further determine the capabilities and/or parameters used to communicate with such assets. The stem cell grid 124 may further comprise the ability to identify specific makes, models, software versions, etc. of the assets and components thereof connected to the actual network 112. The stem cell grid 124 may further still identify the specific network addresses assigned to each asset (e.g., IP addresses, aliases, etc.) as part of determining the characteristics of the actual network 112.

Upon determining the characteristics of the actual network 112, the method continues with the stem cell grid 124 creating a duplicate network, which may correspond to the virtual network 116 (step 208). In some embodiments, the virtual network 116 may be maintained partially or entirely in a virtual machine or hypervisor environment (e.g., as a partition in memory of a server). The assets created on the duplicate network may, in some embodiments, have characteristics assigned thereto that are similar or identical to the characteristics belonging to the assets analyzed in step 204 (step 212).

Once the stem cell grid 124 has successfully created or updated the virtual network 116 to mirror the actual network 112, the stem cell grid 124 may be configured to manage the virtual network 116 as if the virtual network 116 was the actual network 112 (step 216). In some embodiments, the stem cell grid 124 may manage the virtual network 116 by continuously or periodically updating the virtual network 116 and assets connected thereto to reflect or mirror the actual network 112 and assets connected thereto.

With reference now to FIG. 3, a method of responding to a network attack will be described in accordance with embodiments of the present disclosure. The method begins when the sentinel 120 or the stem cell grid 124 detects an attack or potential attack on the actual network 112 (step 304). When such an attack or potential attack is detected, the method proceeds with the sentinel 120 redirecting the source of the attack (e.g., illicit packets, data, media, etc.) from the actual network 120 to the virtual network 116 (step 308). In some embodiments, the redirection of the source of the attack may occur automatically if the sentinel 120 is initially designed to not trust any data incoming to the gateway 108 from the untrusted network 104. In some embodiments, the redirection of the source of the attack may occur in response to detecting incoming data having a signature matching that of known malware, for example.

By sending the source of the attack to the virtual network two useful results are achieved. First, the actual network 112 is insulated and protected from the source of the attack. Second, the source of the attack can be allowed to move throughout the virtual network 116 as if it were infiltrating an actual network. This allows the sentinel 120 to analyze the characteristics of the attack on the virtual network 116 and determine a signature for the attack (step 312). Furthermore, the sentinel 120 or some other malware-countermeasure service may build one or more countermeasures to the attack and employ such countermeasures on the actual network 112 (step 316). For instance, if the attack exhibits a particular weakness on the virtual network 116 (e.g., failure to move from asset to asset if quarantined or not executed at an asset), then the assets on the actual network 112 can be provided with instructions for exploiting the weakness of the attack (e.g., instructions not to execute code having a particular signature).

Accordingly, by employing the virtual network 116, the sentinel 120 is enabled to continuously develop countermeasures for attacks on the actual network 112 without actually exposing the actual network to the source of the attacks. Moreover, the countermeasures can be developed in real-time and deployed in the actual network 112, thereby minimizing the gaps in security updates for the actual network 112.

If data is provided to the virtual network 116 under the assumption that the data “may be” malware or some other form of an attack, but then the data does not manifest itself as an attack, then the data may be re-evaluated and identified as not malicious. After such a re-evaluation and identification, the data may be provided to the assets on the actual network 112. Accordingly, the virtual network 116 can operate as a safe area for the analysis of unknown or untrusted data or packets.

With reference now to FIG. 4, a method of reconstructing a network in response to a network or component failure will be described in accordance with embodiments of the present disclosure. The method begins with the stem cell grid 124 creating snapshots of the actual network 112 intermittently, periodically, or in response to certain triggering events (step 404). The snapshot information can be used to continuously develop and maintain the virtual network 116 as a substantial mirror of the actual network 112.

The method continues when failure of the actual network 112 or a component thereof is detected (step 408). In response to detecting such a failure, the stem cell grid 124 begins reconstructing the last network configuration of the actual network 112 based on the construction of the virtual network 116 (step 412). In some embodiments, this means that the stem cell grid 124 provides the ability to bring back up a degraded network due to DDOS, etc. within minutes. Moreover, the stem cell grid 124 provides the ability to maintain network operational availability (High Availability) and a duplicate network can be created using the same IP addresses. Thus, if necessary, operations of the actual network 112 can be carried out on the virtual network 116 while the actual network 112 is being repaired.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
determining at least one of a cellular function and characteristic of a stem cell; and
incorporating the determined at least one of a cellular function and characteristic into a networking product, thereby enabling the networking product to be automatically replicated.

2. The method of claim 1, wherein the determined at least one of a cellular function and characteristic comprises at least one of cellular growth data, cell dividing characteristics, and cellular duplication algorithms.

3. The method of claim 1, wherein the networking product is configured to be automatically replicated within a virtualized environment.

4. The method of claim 1, wherein the network product is automatically replicated in response to detecting at least one of a failure and loss of power at the network product.

5. The method of claim 1, further comprising:
determining that the network product is under attack or has been attacked by at least one of a computer virus and malware;
quarantining the network product; and
replicating the network product with the stem cell information.

6. The method of claim 5, further comprising:
obtaining information about the network product from a snapshot taken of the network prior to the attack on the network device; and
using the information obtained from the snapshot to replicate the network device in a virtualized environment.

7. The method of claim 6, wherein the virtualized environment comprises a virtual machine hypervisor.

8. A non-transitory computer-readable medium comprising processor-executable instructions that, when executed by a processor, perform a method, the method comprising:
determining at least one of a cellular function and characteristic of a stem cell; and
incorporating the determined at least one of a cellular function and characteristic into a networking product, thereby enabling the networking product to be automatically replicated.

9. The computer-readable medium of claim 8, wherein the determined at least one of a cellular function and characteristic comprises at least one of cellular growth data, cell dividing characteristics, and cellular duplication algorithms.

10. The computer-readable medium of claim 8, wherein the networking product is configured to be automatically replicated within a virtualized environment.

11. The computer-readable medium of claim 8, wherein the network product is automatically replicated in response to detecting at least one of a failure and loss of power at the network product.

12. The computer-readable medium of claim 8, wherein the method further comprises:
determining that the network product is under attack or has been attacked by at least one of a computer virus and malware;
quarantining the network product; and
replicating the network product with the stem cell information.

13. The computer-readable medium of claim 12, wherein the method further comprises:
obtaining information about the network product from a snapshot taken of the network prior to the attack on the network device; and
using the information obtained from the snapshot to replicate the network device in a virtualized environment.

14. The computer-readable medium of claim 13, wherein the virtualized environment comprises a virtual machine hypervisor.

15. A computational system, comprising:
a memory including instructions that, when executed by a microprocessor, perform the following:
determining at least one of a cellular function and characteristic of a stem cell; and
incorporating the determined at least one of a cellular function and characteristic into a networking product, thereby enabling the networking product to be automatically replicated.
a microprocessor configured to execute the instructions stored in the memory.

16. The computational system of claim 15, wherein the determined at least one of a cellular function and characteristic comprises at least one of cellular growth data, cell dividing characteristics, and cellular duplication algorithms.

17. The computational system of claim 15, wherein the networking product is configured to be automatically replicated within a virtualized environment.

18. The computational system of claim 15, wherein the network product is automatically replicated in response to detecting at least one of a failure and loss of power at the network product.

19. The computational system of claim 15, wherein the instructions, when executed by the microprocessor, further perform the following:
determining that the network product is under attack or has been attacked by at least one of a computer virus and malware;
quarantining the network product; and
replicating the network product with the stem cell information.

20. The computational system of claim 19, wherein the instructions, when executed by the microprocessor, further perform the following:
obtaining information about the network product from a snapshot taken of the network prior to the attack on the network device; and
using the information obtained from the snapshot to replicate the network device in a virtualized environment.
